(19) United States
(12) Patent Application Publication
(10) Pub. No.: US 2003/0040928 A1
(43) Pub. Date: Feb. 27, 2003

(54) Cloth rental method, cloth rental program, and cloth rental service receiving method

(75) Inventor: Tomomi Kasahara, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/059,008

(22) Filed: Jan. 30, 2002

(30) Foreign Application Priority Data
Aug. 22, 2001 (JP) 2001-251812

(51) Int. Cl. G06F 17/60

(52) U.S. Cl. 705/1

(57) ABSTRACT

A server is connected via the Internet to a plurality of user terminals. An HDD of the server is stored with various categories of tables and a rental program. The rental program makes a CPU estimate a size of a service target child in a period specified by a user operating the user terminal, recognize a season covering a rental period, extracts a cloth for children having a size coincident with the estimated size of the child and suited to the recognized season, and transmit to the user terminal an article selection screen displaying the extracted cloth.

### BACKGROUND OF THE INVENTION

1. Field of the Invention

The present invention relates to a cloth rental method for renting a cloth for children a user for a fixed period, a cloth rental program for making a computer function as a system for carrying out the cloth rental method, and a cloth rental service receiving method for the user to receive a rental service according to the cloth rental method.

2. Description of the Prior Art

Generally, a user, on the occasion of purchasing a cloth for his or her child, takes into consideration a present size of the child and a growing speed of the child together with a season the cloth should be worn and a sex of the child. Hence, the great majorities of users intentionally select and purchase clothes having slightly larger sizes than the present sizes of their children.

Even if the user purchases a cloth having a slightly larger size by estimating the growing speed of his or her child, however, a child, especially an infant, may grow faster than calculation. Therefore, it might often happen that the size of the cloth become smaller than the size of the child before the cloth is worn down due to the use, with the result that the child is unable to wear the cloth. Further, it might happen that the cloth never be put on, because of a rapid growth of the child as the case may be.

Further, for example, a thin cloth purchased with an intention of having this cloth worn in a hot season might fall into an unwearable state due to a drastic change in the season, though it is not put on so often. In such a case, even if the user tries to have his or her child wear the same cloth in the same season in the next year, the cloth might be often unwearable because the child has grown too much. Note that if this child has a brother or a sister, the brother or the sister might wear the same cloth but will be unable to wear it in a short period of time.

Those clothes for children, which could be used only for the short period of time for the reasons given above, are still wearable in substance, and hence there arises a problem of how the used clothes for children are dealt with in terms of an ecological view. One example of a method of dealing with the used cloth for children is that the used cloth for children is given to and reused by a relative or friend. If nobody receives it, however, there is no alternative but to discard it.

For the reasons elucidated above, there are many users who think it is futile to purchase clothes for children that might be discarded as it is not yet worn at much for the same price as that of a cloth for adult.

### SUMMARY OF THE INVENTION

It is a primary object of the present invention to provide a cloth rental method for renting to a user, at a low cost, a cloth for children having a size matching with a size of a child wearing the cloth within a predetermined period, which is estimated in consideration of his or her growing speed, a cloth rental program for making a computer function as a system for carrying out the cloth rental method, and a cloth rental service receiving method by which the user is able to rent the cloth for children having a size matching with the size of a child wearing the cloth within the predetermined period, which is estimated in consideration of his or her growing speed.

According to a cloth rental method of one aspect of the present invention, when the user makes a request for renting a cloth for children with specifying a rental period, a size of a child wearing the cloth in the rental period is estimated on the basis of growth information acquired by comparing recent size of the child with an average size of children at an age the child becomes in the rental period, and the user is shown a single or a plurality of clothes having a size coincident with the estimated size.

A rental fee per unit period for a cloth can be set lower than a sales price thereof. Therefore, as the cloth rental method according to the present invention is executed, the user can rent a cloth fitted to the size of his or her child simply by selecting a favorite cloth for children among those shown, at a lower cost than purchases it.

The cloth for children shown to the user may be so selected as to be suited to a season covering the rental period.

The clothes rented to a user through the present invention may include not only jackets, shirts, pants, trousers, vests and diaper covers but also whatever wearable such as shoes, caps, gloves, aprons etc. Accordingly, the “size of the child” may be height, weight, length of the sole of the foot, sleeve length, head peripheral length or length of the palm of the hand of the child.

The size of the child in the rental period may be estimated by multiplying the growth information by the average size of children at the age the child becomes in the rental period, based on a numerical value into which an appetite of the child is converted or based on a degree of growth determined from a quantity of foods eaten by the child in the past.

According to the aspect of the present invention, there is also provided a cloth rental program read by a computer connectable to a user terminal. The program makes the computer store growth information acquired by comparing recent size of a child wearing a cloth with an average size of children at an age the child becomes in the rental period, estimate, when receiving from the user terminal a request for renting the cloth with specifying a rental period, a size of the child in the rental period on the basis of the growth information, and transmit the user terminal data for displaying a screen to show a single or a plurality of clothes having a size coincident with the estimated size.

Hence, the cloth rental program makes the computer connected to the user terminal function as the system for carrying out the cloth rental method.

According to a cloth rental service receiving method of another aspect of the present invention, recent size and recent age of a child wearing a cloth and a rental period are specified by a user, and a single or a plurality of clothes coincident with a size of the child in the rental period, which is estimated based on growth information acquired by comparing the recent size of the child with an average size of children at an age the child becomes in the rental period, are shown to the user.

With this method taken, the user is able to rent the cloth for children having the size coincident with the size of the child simply by selecting a favorite cloth among those shown.

### BRIEF DESCRIPTION OF THE DRAWINGS

The invention will be described below in detail with reference to the accompanying drawings, in which:

FIG. 1 is a diagram schematically showing architecture of a computer network system of a first embodiment of the present invention;

FIG. 2 is a block diagram schematically showing an internal circuit of a user terminal;

FIG. 3 is a block diagram schematically showing an internal circuit of a server;

FIG. 4 is a table schematically showing a data structure of a customer master table stored in the server;

FIG. 5 is a table schematically showing a data structure of a child master table stored in the server;

FIG. 6 is a table schematically showing a data structure of an average value master table stored in the server;

FIG. 7 is a table schematically showing a data structure of a growth master table stored in the server;

FIG. 8 is a table schematically showing a data structure of a locality master table stored in the server;

FIG. 9 is a table schematically showing a data structure of an article master table stored in the server;

FIG. 10 is a table schematically showing a data structure of a rental master table stored in the server;

FIG. 11 is a diagram showing an initial screen transmitted to the user terminal from the server and displayed on a display of the user terminal;

FIG. 12 is a flowchart showing a member registration process executed in the server;

FIG. 13 is a diagram showing a member registration screen transmitted to the user terminal from the server and displayed on a display of the user terminal;

FIG. 14 is a diagram showing a log-in screen transmitted to the user terminal from the server and displayed on a display of the user terminal;

FIG. 15 is a diagram showing a menu screen transmitted to the user terminal from the server and displayed on a display of the user terminal;

FIG. 16 is a flowchart showing a child registration process executed in the server;

FIG. 17 is a diagram showing a child registration screen transmitted to the user terminal from the server and displayed on a display of the user terminal;

FIG. 18 is a flowchart showing a growth registration process executed in the server;

FIG. 19 is a diagram showing a growth registration screen transmitted to the user terminal from the server and displayed on a display of the user terminal;

FIG. 20 is a flowchart showing a rental accept process executed in the server;

FIG. 21 is a diagram showing a condition input screen transmitted to the user terminal from the server and displayed on a display of the user terminal;

FIG. 22 is a diagram showing an article selection screen transmitted to the user terminal from the server and displayed on a display of the user terminal;

FIG. 23 is a diagram showing an application screen transmitted to the user terminal from the server and displayed on a display of the user terminal;

FIG. 24 is a diagram showing a trade-in screen transmitted to the user terminal from the server and displayed on a display of the user terminal; and

FIG. 25 is a diagram showing a complaint registration screen transmitted to the user terminal from the server and displayed on a display of the user terminal.

### DESCRIPTION OF THE PREFERRED EMBODIMENT

An embodiment of a cloth rental method according to the present invention will hereinafter be described in detail with reference to the accompanying drawings. Note that the embodiment is an exemplification in which the cloth rental method of the present invention is carried out by utilizing a computer network system.

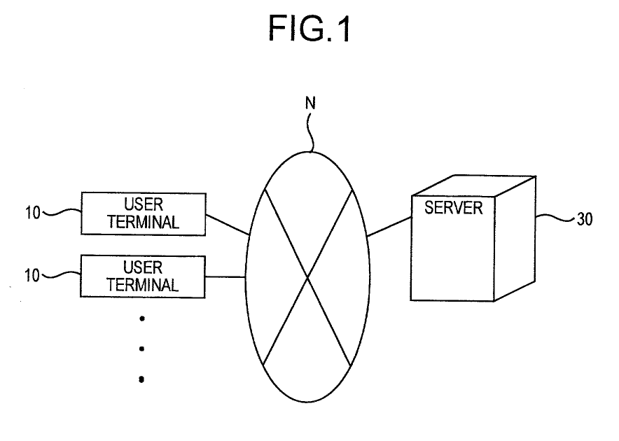

FIG. 1 is a schematic diagram showing architecture of the whole computer network system according to the present embodiment. As shown in FIG. 1, this computer network system is configured by a plurality of user terminals 10 operated by users and a server 20 connected to each other through the Internet N.

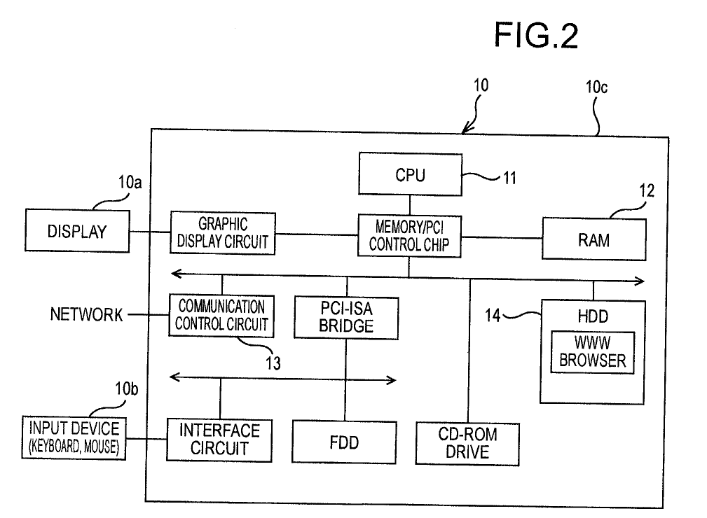

The user terminal 10 is a desktop or notebook type of computer implementing a communication function that is commercially available, or a PDA (Personal Digital Assistant) implementing an Internet access function. FIG. 2 schematically shows architecture of the user terminal 10. As shown in FIG. 2, the user terminal 10 includes a display 10a for displaying a variety of screens, an input device 10b such as a keyboard, a mouse etc, and a main unit 10c to which the display 10a and the input device 10b are connected. The main unit 10c is mainly configured of a CPU 11, a RAM 12, a communication control circuit 13, an HDD 4 and so on.

The CPU 11 is a central processing unit for controlling the devices is the main unit 10c. The RAM 12 is a random access memory, serving to cache various categories of programs read by the CPU 11, on which an operation area for the CPU 11 is developed. The communication control circuit 13 is a network adapter, a modem, a DSU (Digital Service Unit) or an NIC (Network Interface Card) that is connected to the Internet via a communication circuit such as a telephone line or a LAN (Local Area Network). The communication control circuit 13 controls transmitting and receiving data to and from another computer connected to the Internet N.

The HDD 14 is stored with application programs executed by the CPU 11 to actualize various categories of functions, data used in processes executed by the CPU 11, and an OS (Operating System) which makes the CPU 11 perform a system management such as an execution management of the application program, a network management, etc.

Note that the application program stored in this HDD 14 contains information browsing software known as WWW (World Wide Web) Browser. When a URL (Uniform Resource Locator) is inputted to the CPU 11 from the input device 10b, the WWW Browser makes the CPU 11 access a WWW server specified by the URL, request the data file stored at a data storage site specified by the URL, read in a hypertext formatted data in the data file described in HTML (HyperText Markup Language), and display on the display 10a a Web page based on the hypertext formatted data. Note that the data file is transmitted in accordance with a communication protocol suite of TCP/IP (Transmission control Protocol/Internet Protocol) and HTTP (HyperText Transfer Protocol).

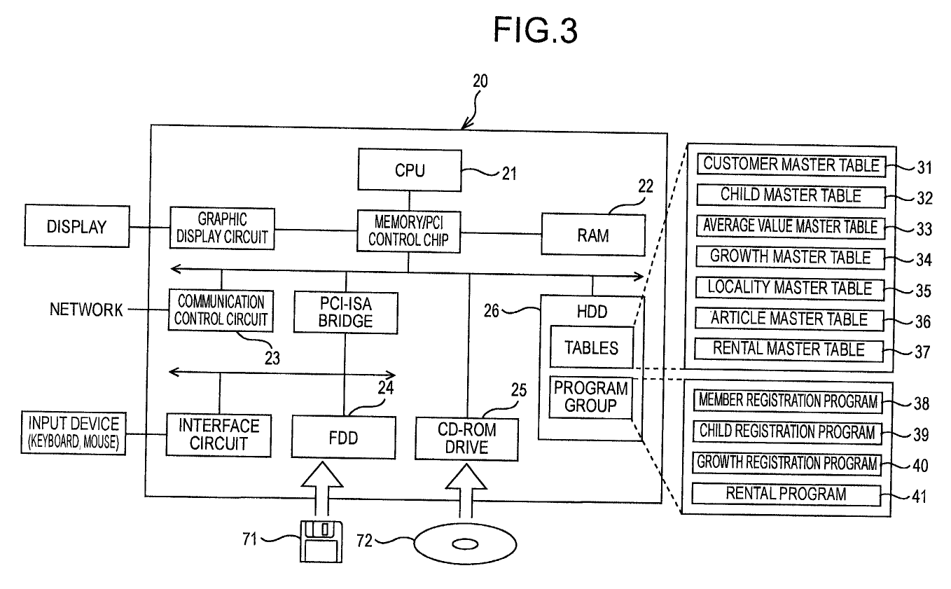

On the other hand, the server 20 shown in FIG. 1 is a computer functioning as a Web server, which transmits, when accessed from a terminal on the Internet N, data for displaying a predetermined Web page back to this terminal. FIG. 3 schematically shows architecture of this server 20. As shown in FIG. 3, the server 20 is mainly configured of a CPU 21, a RAM 22, a communication control circuit 23, an FDD 24, a CD-ROM drive 25 and an HDD 26. It is to be noted that the CPU 21, the RAM 22 and the communication control circuit 23 have the same functions as those shown in FIG. 2, and hence their repetitive explanations are herein omitted.

The FDD 24 and the CD-ROM drive 25 can be respectively loaded with a flexible disk 71 and a CD-ROM disk 72 each containing various categories of programs and data or version-ups thereof to read the programs and data therefrom. Thus read-out programs and data are installed into the HDD 26.

The HDD 26 is stored with application programs executed by the CPU 21 to actualize the variety of functions, data used in the processes executed by the CPU 21, and an OS program makes the CPU 21 perform the execution management of the application program and the network management etc.

Note that the data stored on this HDD 26 include a plurality of hypertext files that contain data for displaying Web pages having various categories of contents. A URL is allocated to each of the storage sites of these hypertext files. The hypertext file is, upon an indication given from the CPU 21, transferred to the terminal having accessed by specifying the URL indicating its storage site.

Further, the HDD 26 is stored with a group of tables used when executing a cloth rental service. The tables includes a customer master table 31, a child master table 32, an average value master table 33, a growth master table 34, a locality master table 35, an article master table 36 and a rental master table 37.

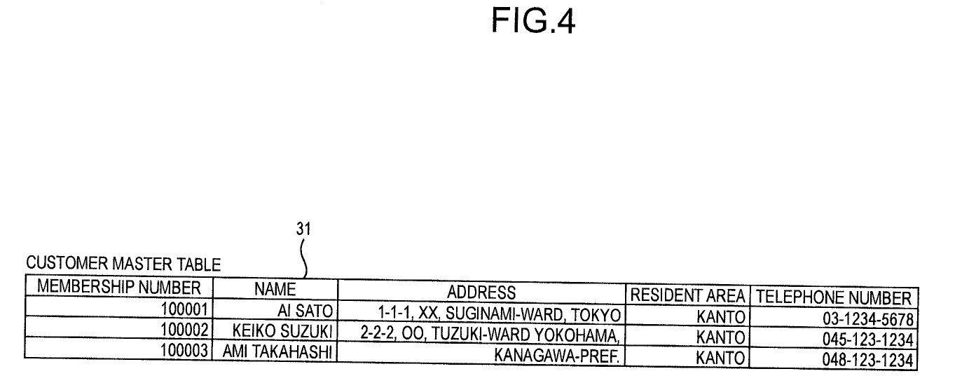

The customer master table 31 is a table for recording pieces of information on the respective users. When the information on a user is recorded in this table 31, it follows that this user is registered as a member. FIG. 4 shows one example of a data structure of the customer master table 31. As shown in FIG. 4, the customer master table 31 has, for every user, a record of data entered in fields such as a “membership number” field, a “name” filed, an “address” field, a “resident area” field and a “telephone number” field.

The “membership number” field is stored with a membership number defined as an identification number unique to the member. The “name”, “address” and “telephone number” fields are respectively stored with a name, an address and a telephone number of the member. The “resident area” field is stored with a name of the area that covers the address of the member. Note that the area indicated by this name of area may be an administratively divided area (district) such as a country, a state, a county and a municipality, or a geometrically divided region belonging to same climate (such as, the northern part, the central part, the southern part, etc.). Incidentally, the customer master table 31 may be stored with pieces of information such as an e-mail address of the member and so on in addition to the data described above.

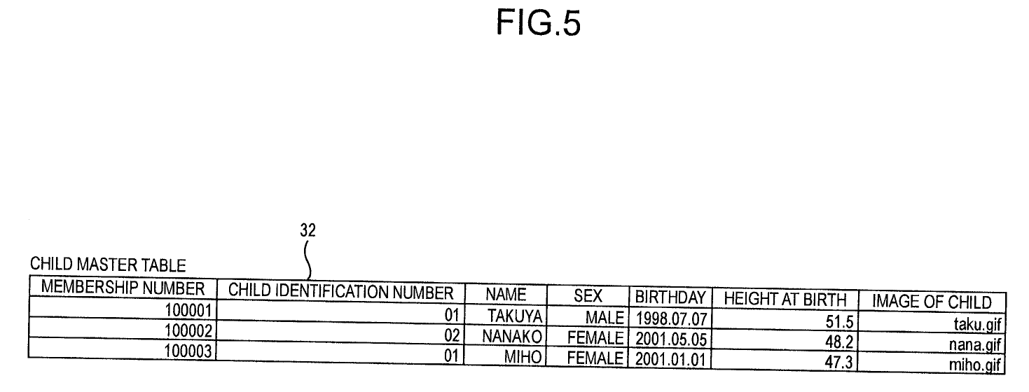

The child master table 32 is a table for recording pieces of information on a child of the individual members. When the information on a child is recorded in this table 32, it follows that the child is registered as a service target child. FIG. 5 shows one example of a data structure of the child master table 32. As shown in FIG. 5, the child master table 32 has, for every child, a record of data entered in fields such as a “membership number” field, a “child identification number” field, a “name” filed, a “sex” field, a “birthday” field, a “height-at-the-birth” field, and an “image-of-child” field.

The “membership number” field is stored with a membership number of the member who registered his or her child. The “child identification number” field is stored with a child serial number as an identification number unique to the individual child registered by one member. The “name”, “birthday” and “height-at-the-birth” fields are respectively stored with a name, a birthday and a height at the birth of the child. The “image-of-child” field is stored with a file name of an image file containing image data of the child. Note that this “image-of-child” field is not essential for the child master table 32. The image data in the image file specified by the file name entered in this “image-of-child” field can be utilized as material for generating, e.g., a grown-up appearance of the child through image processing.

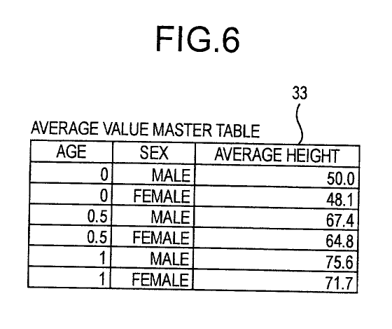

The average value master table 33 is a table for recording average values of the heights of the children according to the sexes and ages. FIG. 6 shows one example of a data structure of the average value master table 33. As shown in FIG. 6, the average value master table 33 is recorded with average heights of the males and females according to the ages (0, 0.5, 1.0, . . . ) note that the unit of the average height in FIG. 6 is centimeter (cm).

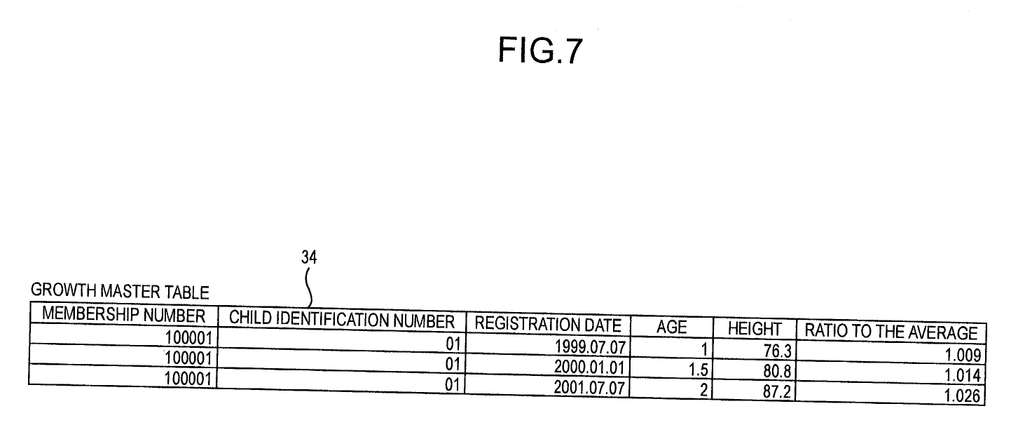

The growth master table 34 is a table recorded with information on a size of the child at an arbitrary point of time. FIG. 7 shows one example of a data structure of this growth master table 34. As shown in FIG. 7, the growth master table 34 has, on every registration date, a record of data entered in fields such as a “membership number” field, a “child identification number” field, a “registration date” field, an “age” field, a “height” field and a “ratio-to-the-average” field.

The “membership number” field and the “child identification number” field are stored with a membership number of the member and an identification number of the member's child. The “registration date” field is stored with a year, a month and a date when the data of this record are registered. The “age” field is stored with an age of the child as of the registration date. The “height” field is stored with a height of the child as of the registration date. The “ratio-to-the-average” field is stored with a ratio of the height of the child to the average height.

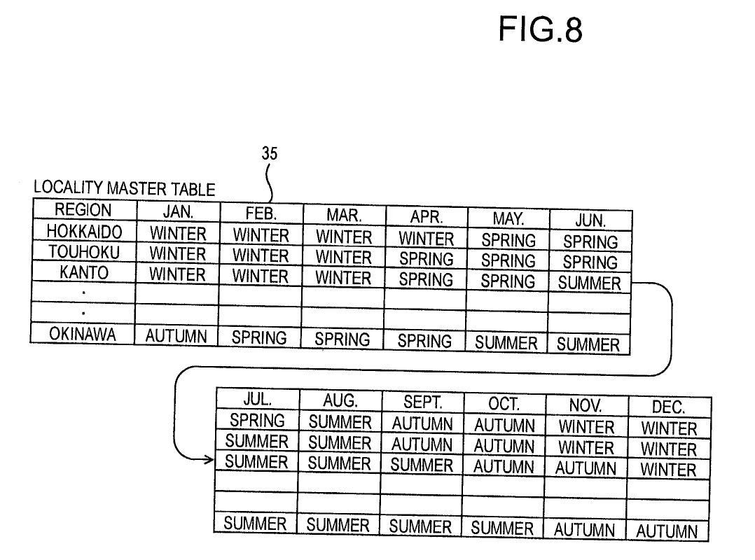

The locality master table 35 is a table defining a season to which each month belongs in every region. FIG. 8 shows one example of a data structure of this locality master table 35. As shown in FIG. 8, the locality master table 35 defines a season to which each month belongs for every name of the region (the Hokkaido area, the Tohoku area, the Kanto area, . . . , Okinawa).

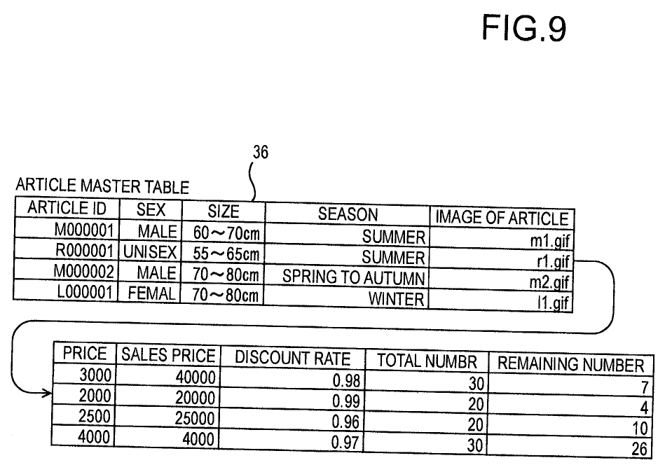

The article master table 36 is a table for recording pieces of information on articles (clothes for children) rented to the member. FIG. 9 shows one example of a data structure of this article master table 36. As shown in FIG. 9, the article master table 36 has, for every article, a record of data entered in fields such as an “article ID” field, a “sex” field, a “size” field, a “season” field, an “image-of-article” field, a “price” field, a “sales price” field, a “discount rate” field, a “total number” field, and a “remaining number” field.

The “article ID” field is stored with article identifying information unique to the cloth for children to be leased. The “sex” field is stored with a sex of the rental target child of the cloth. The “size” field is stored with a range of height fitted to the cloth. The “season” field is stored with the seasons during which the cloth can be used. The “image-of-article” field is stored with a file name of an image file containing the image data of the cloth. Note that the image file specified by the file name entered in this “image-of-article” field is stored in the HDD 26. The “price” field is stored with, for example, a rental fee for the cloth per week. The “sales price” field is stored with a price set in the case the cloth is sold. The “discount rate” field is stored with a discount rate by which the rental fee is multiplied in the case the cloth is consecutively leased over a long period of time. For instance, in case the member consecutively rents for three weeks a cloth for children of which rental fee is 3,000 yen per week and a discount rate is 0.98, the rental fee is set 3,000 yen for the first week, 2,940 (3,000×0.98) yen for the second week and 2,881 (3,000×0.98×0.98) for the subsequent third week. Accordingly, a total amount of rental fee in that case is 3,000×(1+0.98+0.09×0.98)=8821 yen. The “total number” field is stored with a total number of the clothes for children prepared for the rental service. The “remaining number” field is stored with the number of the clothes for children stocked. Note that the height of the child is treated as a size of the child, and the size of the cloth is indicated by the height in this embodiment, however, pieces of information on a weight or other items of physical data may also be utilized.

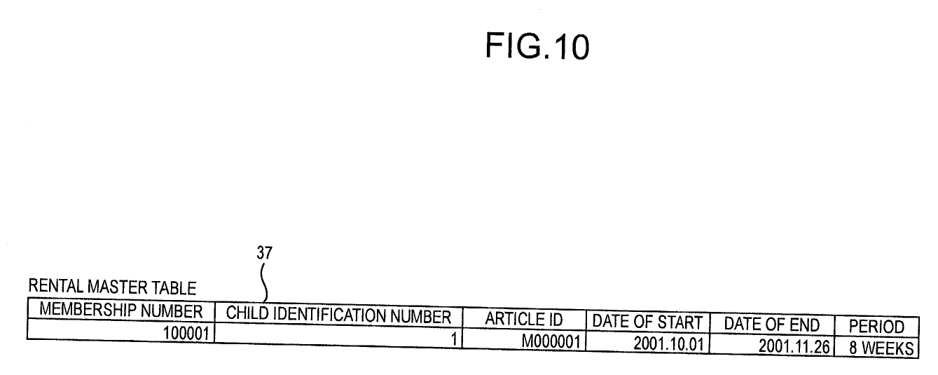

The rental master table 37 is a table for recording information on the clothes for children rented to the members. FIG. 10 shows one example of a data structure of this rental master table 37. As shown in FIG. 10, the rental master table 37 has, for every cloth for children, a record of data entered in fields such as a “membership number”, a “child identification number”, an “article ID” field, a “date-of-start” field, a “date-of-end” field, and a “period” field.

The “membership number”, “child identification number” and “article ID” fields are stored respectively with a membership number of the member who rents the cloth, a child identification number of the child as a wearer of the same cloth and an article identifying information of the same cloth. The “period”, “date-of-start” and “date-of-end” fields are stored respectively with a length of period for which the cloth for children is leased, a date (year/month/date) of the start of this period, and a date of the end (year/month/date) of this period.

Further, the HDD 26 is stored with a group of programs executed when carrying out the cloth rental service. This program group contains a member registration program 38, a child registration program 39, a growth registration program 40 and a rental program 41.

The member registration program 38 makes the CPU 21 accept the information for registering the member from the user terminal 10, generate log-in information when the same member registering information is sent thereto, records the member registering information and the log-in information in the customer master table 31, and notify the user terminal 10 of the log-in information.

The child registration program 39 makes the CPU 21 accept the information on the size of the child from the user terminal 10, generates information on a growth of the child on the basis of the size information when the same size information is sent thereto, and record the size information and the growth information of the child in the growth master table 34.

The rental program 41 makes the CPU 21 estimate a size of the child within a period specified by the member operating the user terminal 10, recognize a season that covers this period, extract a cloth for children suited to the estimated size of the child and the recognized season, and transmit a screen indicating the extracted cloth to the user terminal 10.

Note that the program group containing the programs 38 through 41 may also be read from the flexible disk 71 or the CD-ROM disk 72 through the FDD 24 or the CD-ROM drive 25 and installed into the HDD 26.

Next, processes executed in the computer network system having the architecture described above will be explained.

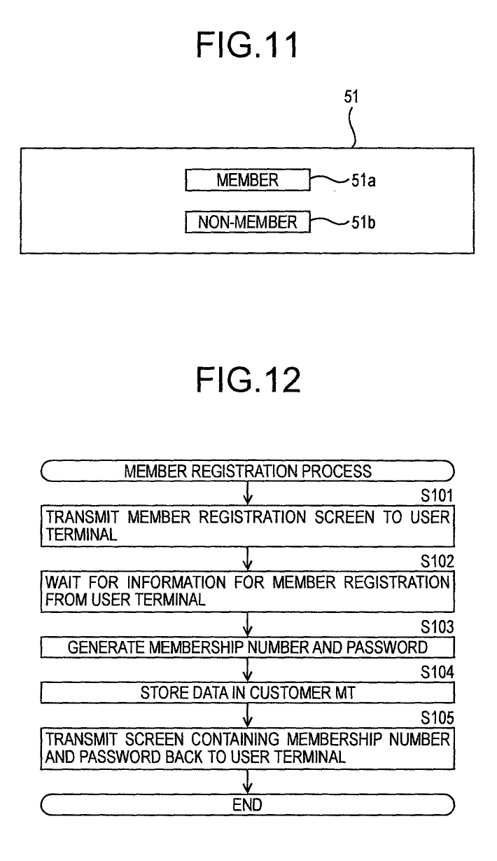

With such an event that the user operates the user terminal 10, the WWW Browser of the user terminal 10 transmits an information browse request message to the server 20. Then, an initial screen is sent back to the user terminal 10 from the server 20 and displayed on the display 10a of the user terminal 10. As shown in FIG. 11, an initial screen 51 contains a “member” button 51a that the user whose membership is registered is allowed to click on, and a “non-member” button 51b that the user unregistered as a member is allowed to click on.

<Member Registration and Authentication>

If the user clicks on the “non-member” button 51b in a state where the initial screen 51 is displayed on the display 10a, the CPU 21 reads the member registration program 39 to start a member registration process in the server 20. FIG. 12 shows a content of this member registration process.

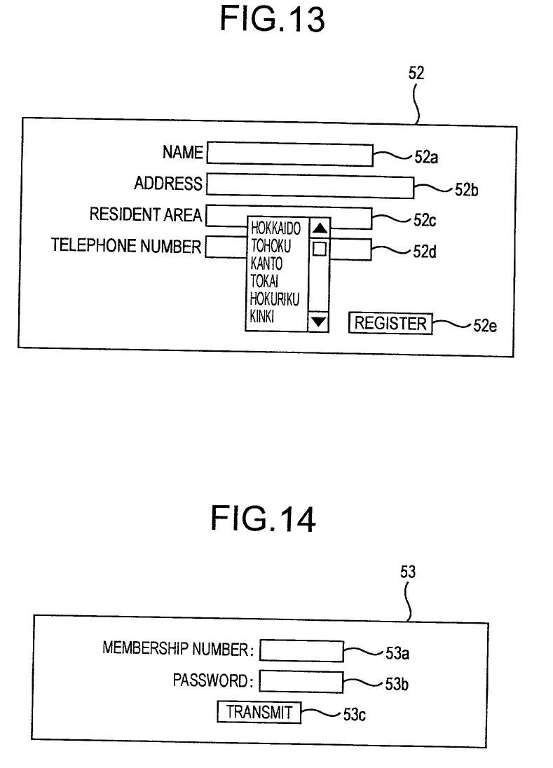

As shown in FIG. 12, in first step S101 after starting the member registration process, the CPU 21 transmits the member registration screen to the user terminal 10. As illustrated in FIG. 13, a member registration screen 52 contains text boxes 52a to 52d for inputting a name, an address, a resident area and a telephone number, respectively. Further, the member registration screen 52 also contains a “register” button 52e clicked on by the user when the user finishes entering (inputting) the respective pieces of information in the text boxes 52a through 52d. Note that the text box 52c is provided with a function of a pull-down menu as shown in FIG. 13, wherein, if any one of region names listed in the pull-down menu box is selected and clicked on, the selected region name is inputted into the text box 52c. Then, the CPU 21 transmits the member registration screen 52 to the user terminal 10, and thereafter advances the processing to S102.

In S102, the CPU 21 waits for pieces of information necessary for member registration, to be specific, the name, the address, the resident area and the telephone number to be transmitted from the user terminal 10. Note that the information necessary for member registration input into the text boxes 52a through 52d is transmitted from the user terminal 10 to the servere, when the user clicks on the “register” button 52e on the member registration screen 52 displayed on the display 10a in the user terminal 10. Then, the CPU 21, upon receiving the information necessary for member registration from the user terminal 10, advances the processing to S103.

In S103, the CPU 21 generates a combination of the membership number and a log-in password in a way that corresponds to the received information necessary for member registration.

In next step S104, the CPU 21 stores the customer MT (master table) 31 with the information necessary for member registration (the name, the address, the resident area and the telephone number) received in S102 and the membership number generated in S103. Simultaneously, the CPU 21 registers the combination of the password and the membership number generated in S103 in an unillustrated authentication table.

In next step S105, the CPU 21 generates a screen in which the membership number and the password generated in S103 are described, and transmits this screen to the user terminal 10. Then, the CPU 21 finishes the member registration process.

With the member registration process thus executed, the information on the user is stored in the customer MT 31 (which means that this user is registered as a member), and the same user is notified of the membership number and the password used when enjoying the service as a member.

On the other hand, the user clicks on the “member” button 51a in a state where the initial screen 51 shown in FIG. 11 is displayed on the display 10a of the user terminal 10, a log-in screen shown in FIG. 14 is sent back to the user terminal 10 from the server 20 and displayed on the display 10a. Then, the user inputs the membership number and the password into the two text boxes 53a, 53b contained in the log-in screen 53, respectively, and clicks on a “transmit” button 53c, thereby transmitting the membership number and the password to the server 20.

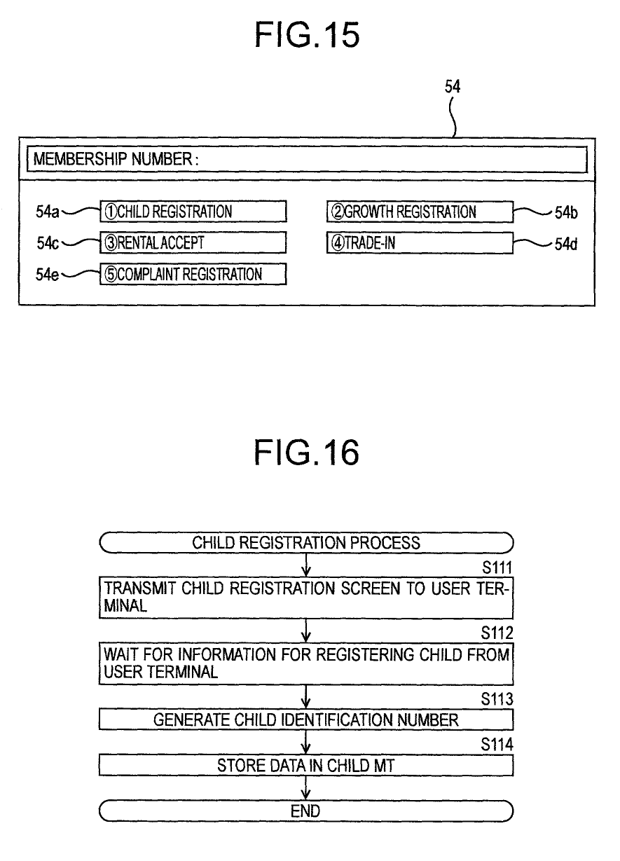

Then, the server 20 checks whether or not the combination of the membership number and the password received has already been registered in the unillustrated authentication table. If it is not registered, the screen indicating this purport is transmitted back to the user terminal 10. Whereas if it is registered, a menu screen 54 is sent back to the user terminal 10. As shown in FIG. 15, a menu screen 54 indicates the membership number to be inputted at the log-in by the member, and contains five pieces buttons, i.e., a “child registration” button 54a, a “growth registration” button 54b, a “rental accept” button 54c, a “trade-in” button 54d and a “complaint registration” button 54e that can be clicked on by the member.

The “child registration” button 54a is a button clicked on when the member registers his or her child. The “growth registration” button 54b is clicked on when the member registers a size of the child. The “rental accept” button 54c is clicked on when the member makes an application for renting a cloth for his or her child. The “trade-in” button 54d is clicked on when the member sells his or her own cloth for his or her child to a rental service provider. The “complaint registration” button 54e is clicked on when the member makes a claim on the rental service against the service provider.

Contents of processes occurred by the member clicking on the respective buttons 54a through 54e on the menu screen 54, will be explained in sequence.

<Child Registration>

When the member clicks on the “child registration” button 54a in the state where the menu screen 54 shown in FIG. 15 is displayed on the display 10a of the user terminal 10, the CPU 21 reads in the child registration program 39 to start a child registration process in the server 20. FIG. 16 shows a content of this child registration process.

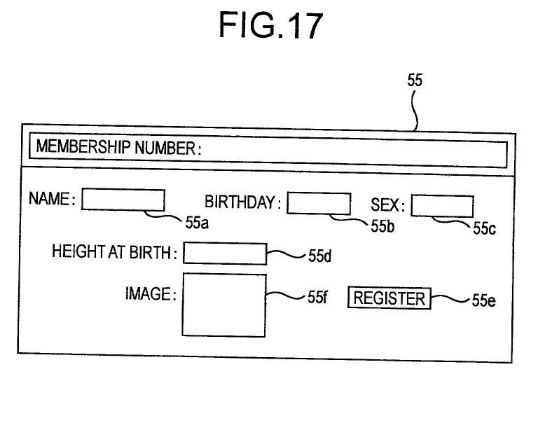

As shown in FIG. 16, in first step S111 after starting the child registration process, the CPU 21 transmits a child registration screen to the user terminal 10. As shown in FIG. 17, the child registration screen 55 contains text boxes 55a to 55d for inputting a name, a birthday, a sex and a height at the birth, respectively. Further, the child registration screen 55 also contains a “register” button 55e clicked on by the member when the member finishes inputting the respective pieces of information into the text boxes 55a through 55d. Further, the child registration screen 55 indicates a membership number to be inputted by the member at the log-in and contains a box 55f for pasting an image of the child. Note that this box 55f is not essential as in the case of the “child image” field in the child MT (master table) 32. Then, the CPU 21 transmits the child registration screen 55 to the user terminal 10, and thereafter advances the processing to S112.

In S112, the CPU 21 waits for pieces of information for registering child, i.e., the name, the birthday, the sex and the height at the birth to be transmitted from the user terminal 10. Note that the information necessary for registering child inputted into the text boxes 55a through 55d is transmitted from the user terminal 10 to the server 20, when the member clicks on the “register” button 55e on the child registration screen 55 displayed on the display 10a in the user terminal 10. At this time, if the image is pasted to the box 55f on the child registration screen 55, a process of transmitting the image data of the image to the server 20 is also executed simultaneously with the process of transmitting the information necessary for registering child. Then, the CPU 21, upon receiving the information necessary for registering child from the user terminal 10, advances the processing to S113.

In S113, the CPU 21 generates a child identification number in a way that corresponds to the received information necessary for registering child.

In next step S114, the CPU 21 stores the child MT 32 with the information necessary for registering child (the name, the birthday, the sex and the height at the birth) received in S122, the child identification number generated in S113 and the membership number indicated on the child registration screen 55. Note that if the image data are received in S112, the CPU 21 stores an image file containing the same image data in the HDD 26, and also stores a file name of this image file in the child MT 32. Then, the CPU 21 finishes the child registration process.

With the child registration process thus executed, the information on the child is stored in the child MT 32, and the child is registered as the service target child.

<Growth Registration>

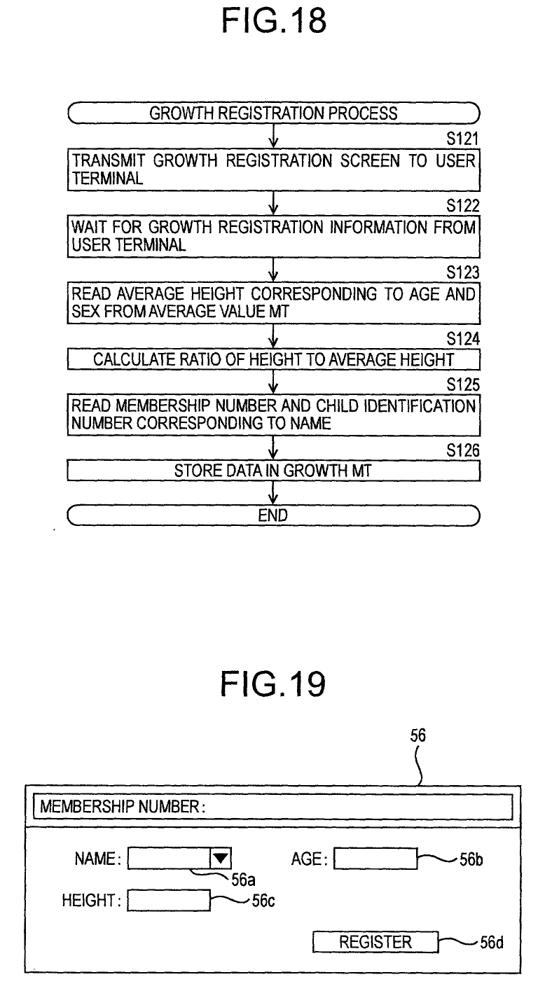

When the member clicks on the “growth registration” button 54b in a state where the menu screen 54 shown in FIG. 15 is displayed on the display 10a of the user terminal 10, the CPU 21 reads in a growth registration program 40 to start a growth registration process in the server 20. FIG. 18 shows a content of the growth registration process.

As shown in FIG. 18, in first step S121 after starting the growth registration process, the CPU 21 transmits a growth registration screen to the user terminal 10. As shown in FIG. 19, the growth registration screen 56 contains text boxes 56a to 56c for inputting a name, an age and a height, respectively. Further, the growth registration screen 56 contains a “register” button 56d clicked on by the member when the member finishes inputting the respective pieces of information into the text boxes 56a through 56c. Further, the growth registration screen 56 indicates a membership number inputted at the log-in by the member. Note that the text box 56a may be provided with a function of a pull-down menu, wherein all the names of the children whose child identification numbers correspond to the membership numbers of the members are listed in a pull-down menu box and, when the member selects and clicks on one of the listed children's names, this selected name is inputted into the text box 56a. Subsequently, the CPU 21 transmits the growth registration screen 56 to the user terminal 10, and thereafter advances the processing to S122.

In S122, the CPU 21 waits for the growth registration information, i.e., the name, the age and the height to be transmitted from the user terminal 10. It is to be noted that the growth registration information inputted into the respective text boxes 56a-56c is transmitted from the user terminal 10 to the server 20, when the member clicks on the “register” button 56d on the growth registration screen 56 displayed on the display 10a in the user terminal 10. Then, the CPU 21, upon receiving the growth registration information from the user terminal 10, advances the processing to S123.

In S123, the CPU 21 reads from the average value MT (master table) 33 an average height corresponding to a combination of the age and the sex that are contained in the growth registration information received in S122.

In next step S124, the CPU 21 divides the height received in S122 by the average height read in S123, thus obtaining a ratio thereof.

In next step S125, the CPU 21 reads from the child MT 32 a membership number and a child identification number that correspond to the name received in S122.

In next step S126, the CPU 21 stores the growth MT 34 with the age and the height received in S122, the ratio calculated in S124, the membership number and the child identification number read in S125, and a year/month/date at this point of time. Then, the CPU 21 finishes the growth registration process.

With the growth registration process thus executed, the information on the size of the child at the arbitrary point of time is stored in the growth MT 34.

<Rental Acceptance>

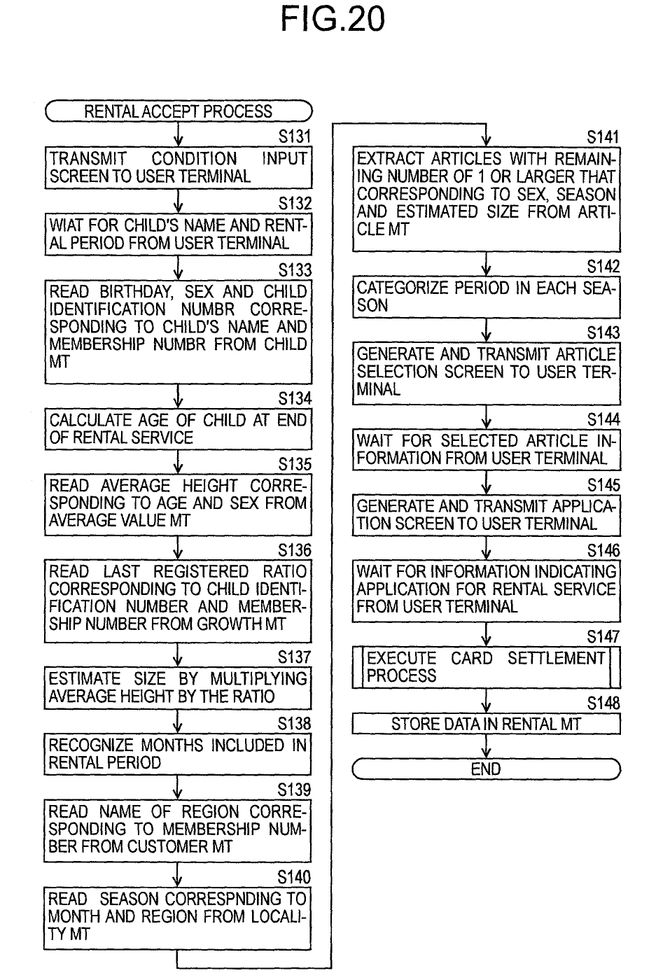

When the member clicks on the “rental accept” button 54c in a state where the menu screen 54 shown in FIG. 15 is displayed on the display 10a of the user terminal 10, the CPU 21 reads the rental accept program 41 to start a rental accept process in the server 20. FIG. 20 shows a content of this rental accept process.

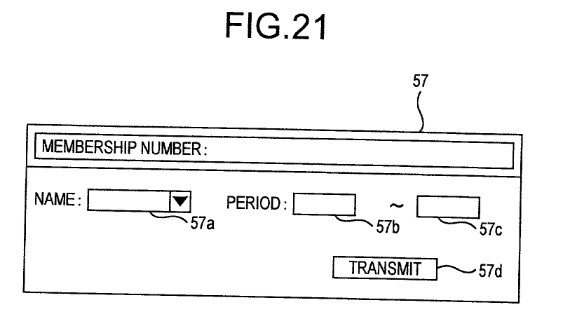

As shown in FIG. 20, in first step S131 after starting the rental accept process, the CPU 21 transmits a condition input screen to the user terminal 10. As shown in FIG. 21, the condition input screen 57 contains text boxes 57a to 57c for inputting a name, a date of the start of a rental period and a date of the end of the rental period, respectively. Further, the condition input screen 57 contains a “transmit” button 57d clicked on by the member when the member finishes inputting the respective pieces of information into the text boxes 57a through 57c. Further, the condition input screen 57 indicates a membership number inputted at the log-in by the member. Note that the text box 57a may be provided with the same pull-down menu function as that of the text box 56a on the growth registration screen 56. Then, the CPU 21 transmits the condition input screen 57 to the user terminal 10, and advances the processing to S132.

In S132, the CPU 21 waits for a name of the service target child and a rental period to be transmitted from the user terminal 10. It is to be noted that the child's name and the rental period inputted into the respective text boxes 57a-57c are transmitted from the user terminal 10 to the server 20, when the member clicks on the “transmit” button 57d on the condition input screen 57 displayed on the display 10a in the user terminal 10. Then, the CPU 21, upon receiving the child's name and the rental period from the user terminal 10, advances the processing to S133.

In S133, the CPU 21 reads from the child MT 32 a birthday, a sex and a child identification number which correspond to the child's name and the membership number received in S132.

In next step S134, the CPU 21 calculates an age the child becomes at the end of the rental period on the basis of the birthday read out in S133.

In next step S135, the CPU 21 reads from the average value MT 33 an average height corresponding to the combination of the sex read out in S133 and the age calculated in S134.

In subsequent step S136, the CPU 21 reads, from the growth MT 34a, a value of “ratio-to-the-average” field, that is ratio, corresponding to the combination of the child identification number and the membership number read out in S133 and last registered in S126.

In next step S137, the CPU 21 multiplies the average height read out in S135 by the value of “ratio-to-the-average” that is a ratio read out in S136, thus estimating a size of the child at the end of the rental period. Note that if the rental period extends long, the rental period is sectioned by every fixed period of time of, e.g., three months, and an estimated size is obtained (calculated) for every fixed period.

In next step S138, the CPU 21 recognizes a month(s) covering the rental period. For example, if the rental period ranges from August 25 to August 31, the CPU 21 recognizes it as “August”. If the rental period ranges from August 25 to September 14, the CPU 21 recognizes it as “August” and “September”. If the rental period ranges from August 25 to December 7, the CPU 21 recognizes it as “August” through “December”.

In subsequent step S139, the CPU 21 reads a name of region that corresponds to the membership number indicated in the condition input screen 57 from the customer MT 31.

In next step S140, the CPU 21 reads from the locality MT 35 a season corresponding to the months recognized in S138 and the name of region that is read out in S139. For instance, if the region is the Tohoku area and the month covering the rental period is only August, the CPU 21 reads out “summer”. In the case of August and September, “summer” and “autumn” are read out. In the case of August through December, “summer”, “autumn” and “winter” are read out.

In next step S141, the CPU 21 extracts from the article MT 36 a record containing the estimated size obtained in S137 and the season read out in S140 and exhibiting a remaining number of 1 or larger.

In next step s142, the CPU 21 categorizes the rental period into the seasons read out in S140. For example, if the region is the Tohoku area and the rental period ranges from August 25 to August 31, the CPU 21 categorizes it all as summer. If the rental period ranges from August 25 to September 14, the CPU 21 categorizes a period of August 25 through August 31 as summer and a period of September 1 through September 14 as autumn. If the rental period ranges from August 25 to December 7, the CPU 21 categorizes the period of August 25 through August 31 as summer, a period of September 1 through October 31 as autumn and a period of November 1 through December 7 as winter.

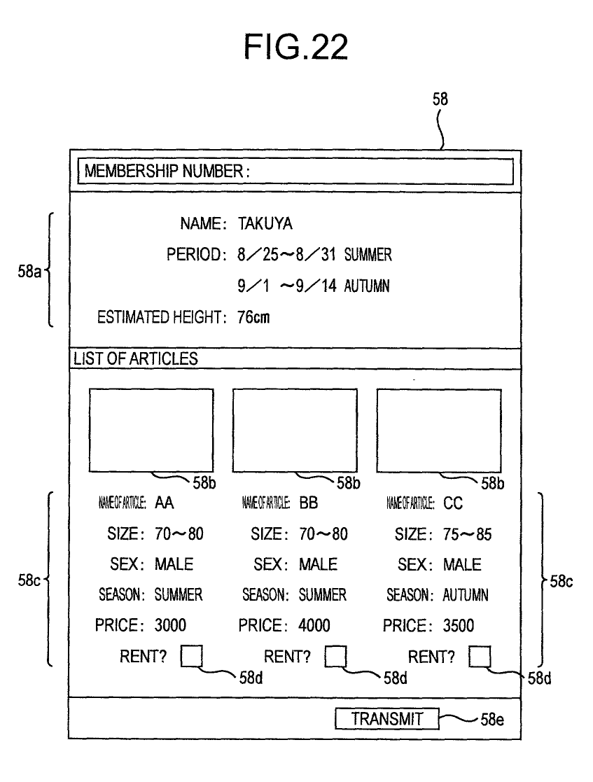

In next S143, the CPU 21 generates an article selection screen for indicating information on an article corresponding to each record extracted in S141, and transmits this screen to the user terminal 10. As shown in FIG. 22, the article selection screen 58 contains a display area 58a for indicating a name of the service target child, a rental period categorized into the seasons in S142 and an estimated size obtained in S137. Further, this article selection screen 58 contains, for every article corresponding to each record extracted in S141, an article image box 58b for showing an article image corresponding to the image file name in this record, an other information box 58c for indicating other items of information in the same record and a check box 58d into which the member inputs check mark when selecting the article. Moreover, the article selection screen 58 contains a “transmit” button 58e clicked by the member when the member finishes inputting the check marks into the check boxes 58d. Note that the article selection screen 58 indicates the membership number inputted at the log-in by the member. Then, the CPU 21 transmits the article selection screen 58 to the user terminal 10, and advances the processing to S144.

In S144, the CPU 21 waits for the information on the article selected by the member to be transmitted from the user terminal 10. It is to be noted that a piece of information indicating whether the check mark has been inputted into the check box 58d of each article is transmitted to the server 20, when the member clicks on the “transmit” button 58e on the article selection screen 58 in the user terminal 10. Then, the CPU 21, upon receiving from the user terminal 10 the information indicating whether each article has been selected, advances the processing to S145.

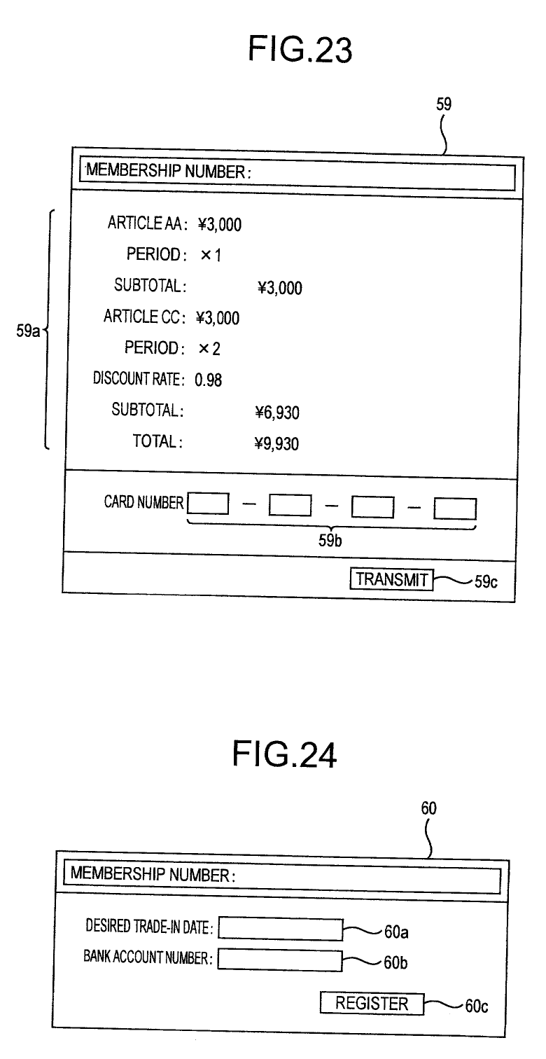

In S145, the CPU 21 generates an application screen on the basis of the records corresponding to the articles which is indicated to be selected by the information received in S144 among the records extracted in S141, and transmits the application screen to the user terminal 10. As shown in FIG. 23, an application screen 59 indicates details 59a of the articles selected by the member. To be more specific, a rental fee and a discount rate in the record corresponding to the selected article, a subtotal of the rental fee that is determined based on the rental fee, the discount rate and the number of weeks contained in the rental period, and a total as a total sum of the subtotals, are indicated with respect to each article selected by the member. Further, the application screen 59 contains a text box 59b for inputting a card number of a credit card. Moreover, the application screen 59 contains a “transmit” button 59c clicked by the member when the member finishes inputting the card number into the text box 59b. Still further, the application screen 59 indicates the membership number inputted at the log-in by the member. Then, the CPU 21 transmits the application screen 59 to the user terminal 10, and advances the processing to S146.

In S146, the CPU 21 waits for the information indicating that the member applies for the rental service to be transmitted from the user terminal 10. Note that a member's intention of applying for the rental service and the card number inputted into the text box 59 are transmitted from the user terminal 10 to the server 20, when the member clicks on the “transmit” button 59c on the application screen 59 displayed on the display 10a in the user terminal 10. Then, the CPU 21, upon receiving the member's intention of applying for the rental service and the card number inputted into the text box 59 from the user terminal 10, advances the processing to S147.

In S147, the CPU 21 executes a card settlement process. Note that this card settlement process is the same as what is generally done, and hence a detailed explanation thereof is herein omitted. In short, however, a host computer (unillustrated) of a credit card company which is connected via a leased network to the server20 is notified of the card number and the total amount of money, and the CPU 21 waits for a piece of information indicating whether the settlement has been done to be sent back from the host computer. When the host computer notifies the CPU 21 of the information indicating that the settlement has been done, the CPU 21 transmits the screen indicating that the settlement has been completed to the user terminal 10. If the host computer notifies the CPU 21 of a piece of information indicating that the settlement is not done, the CPU 21 executes a process of transmitting to the user terminal 10 a screen indicating that the settlement is not done.

In next step S148, the CPU 21 stores the rental MT 37 with a record about each article described in the details 59a on the application screen, which consists of pieces of data such as the membership number, the child identification number recognized in S133, an article ID of the article, dates of the start/end of the rental period and a length of the rental period. Then, the CPU 21 finishes the rental accept process.

With the rental accept process thus executed, the member is notified of the extracted articles satisfying the conditions desired by the member, and the rental MT 37 is stored with the information on the articles selected by the member among the extracted articles as the article information on the articles to be rented to the member.

<Purchase Acceptance>

When the member clicks on the “trade-in” button 54d in a state where the menu screen 54 shown in FIG. 15 is displayed on the display 10a of the user terminal 10, the server 20 transmits data for displaying a trade-in screen 60 shown in FIG. 24 to the user terminal 10, and this trade-in screen 60 is displayed on the display 10a of the user terminal 10.

The trade-in screen 60 is a screen for notifying the service provider of a purport that a cloth for children which is still wearable but unnecessary is put for trade-in. The trade-in screen 60 contains a text box 60a for inputting a desired date the cloth for children is traded in, and a text box 60b for inputting a bank account number to which an amount of trade-in allowance on the cloth is transferred. Further, the trade-in screen 60 contains a “register” button 60c clicked on by the member when the member finishes inputting respective pieces of information into the text boxes 60a, 60b. Moreover, the trade-in screen 60 indicates the membership number inputted at the log-in by the member.

Then, when the member clicks on the “register” button 60c after inputting a desired date into the text box 60a and the member's own bank account number into the text box 60b, the server 20 is notified of the date and the bank account number inputted into the text boxes 60a, 60b by the user terminal 10. The service provider collects the cloth for children to be traded-in on the date of which the server 20 has been notified, determines a trade-in allowance by checking the collected cloth, and transfers an amount of the trade-in allowance to the bank account number.

With the purchase accept process thus executed, the member is able to sell a cloth for children useless to himself or herself without discarding the same cloth. On the other hand, the service provider is able to collect the article usable for the rental service.

<Complaint Registration>

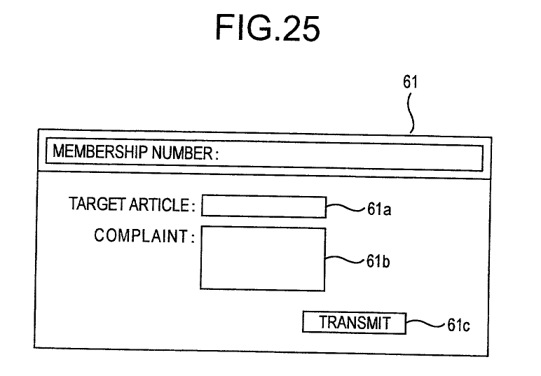

When the member clicks on the “complaint registration” button 54e in a state where the menu screen 54 shown in FIG. 15 is displayed on the display 10a of the user terminal 10, the server 20 transmits data for displaying a complaint registration screen 61 shown in FIG. 25 to the user terminal 10, and this complaint registration screen 61 is displayed on the display 10a of the user terminal 10.

This complaint registration screen 61 contains a text box 61a for inputting a name of a complaint target article, a text box 61b for inputting a content of the complaint, and a “transmit” button 61c. When making a complaint based on the fact that, for example, the article is torn or has uncleanable dirt (stains), the member inputs the contents of the complaints into the text boxes 61a, 61b, and clicks on the “transmit” button 61c. Then, the information inputted into the text boxes 61a, 61b is transmitted to the server 20. The service provider is able to cope with the complaint in accordance with the received information.

Note that a process of indicating a delivery of the article is executed in parallel with the above processes in the server 20. More specifically, the CPU 21 checks the “date-of-start” field in the rental MT 37 once a day. Then, if there is a record in which the very day of the processing is stored as the date of the start of the rental period, the CPU 21 subtracts “1” from a numerical value recorded in the “remaining number” field in the record of the article MT 36 of which article ID is same as that record in the rental MT 37, and notifies a delivery center terminal (unillustrated) of the article ID, the membership number and the date of the start of the rental priod. A worker at the delivery center carries out a procedure or work for delivering the article identified by the article ID to an address of the member defined by the membership number.

Further, a process of indicating a collection of the article is executed in parallel with the above processes in the server 20. To be more specific, the CPU 21 checks the “date-of-end” field in the rental MT 37 once a day. Then, if there is a record in which the very day of the processing is stored as the date of the end of the rental period, the CPU 21 notifies a tie-up cleaning shop terminal (unillustrated) of an article ID, a name of the member specified by the membership number and an address. A worker at the cleaning shop goes to the address of the member to receive the article that should be collected. Then, the worker at the cleaning shop, upon finishing the cleaning of the collected article, delivers this cleaned article to the delivery center described above.

As discussed above, according to the present embodiment, the member accessing the server 20 by operating the user terminal 10 inputs the name of his or her child and the rental period on the condition input screen 57 displayed on the display 10a, and clicks on the “transmit” button 57d, whereby the clothes for children suited to the wearing seasons and the estimated sizes are extracted and pieces of information on these extracted clothes are displayed on the article selection screen 58. Then, the member selects a favorite one among those clothes displayed on the article selection screen 58, and clicks on the “transmit” button 58e, whereby the member can rent this selected cloth. Thus, the member is able to rent the desired cloth only for a desired period and can therefore restrain the expenditure to clothes for his or her child to a greater degree than purchases the cloth. Further, there is no necessity of discarding the cloth for children remaining still valuable.

Moreover, the article is delivered to member's home at the start of the rental period, and the worker at the cleaning shop comes to member's home to collect the article at the end of the rental period. Therefore, for example, even a person who is hard to go out because of having a few children can supply his or her children with desired clothes.

Note that the above discussion is based on the premise that the information in the average value MT 33 is prepared in advance, however, the present invention may not be limited to this premise. For instance, if many pieces of data are accumulated in the growth MT 34, the average value to be stored in the average value MT 33 may be calculated based on these pieces of data. Alternatively, there may be taken such architecture that the system ties up with some hospitals, the terminals at the hospitals are connected to the server 20 via the network N, average value data accumulated in the hospitals are transmitted to the server 20, and the records in the growth master table 34 are transmitted to the terminals at the hospitals. With this architecture adopted, the server 20 is capable of making use of newest pieces of average value data at all times on one hand, and the hospitals can accumulate a larger quantity of data at to children on the other hand.

Further, the size of the child is estimated as the height of the child in the discussion given above. This is because the sizes of clothes for children are defined based on the height in the great majority of cases. Even a case where the sizes of the clothes are defined based on what is other than the height, the cloth rental method of the present invention can be carried out. To be specific, in addition to the height, for example, a weight, a sleeve length, a length of the sole of the foot, a length of the palm of the hand and a head size (head peripheral length) can be utilized as the size of the child.

Note that the present invention is not limited to the embodiment discussed above. For instance, if the rental period extends long, the rental period is sectioned by every fixed period of time of, e.g., three months, the estimated size is obtained for every fixed period in S137 in FIG. 20, and the server 20 may give an indication of delivering or collecting the article for each sectioned period. With this contrivance, the article more suited to a physical state of the child can be rented to the member.

Further, the ratio last registered in the growth MT 34 is read in S136 in FIG. 20 and utilized in S137. As a substitute for this, however, the condition input screen 57 may be provided with a field for inputting the physical information of the child at the application for the rental service, and a ratio to be utilized in S137 may be calculated based on the inputted data.

Moreover, the article selection screen 58 in FIG. 22 may contain check boxes to which the member inputs check marks to purchase articles in addition to the check boxes 58d to which the member inputs check marks to rent the articles. With this contrivance, if the member desires to purchase the article, this desire can be satisfied.

As discussed above, according to the present invention, the user is able to rent the cloth for children fitted to the estimated size of his or her child corresponding to a growth of the child at a lower cost than purchases it.

We claim:

1. A cloth rental method for renting a cloth for children to a user, comprising steps of:
estimating, when the user makes a request for renting a cloth with specifying a rental period, a size of a child wearing the cloth in the rental period on the basis of growth information acquired by comparing recent size of the child with an average size of children at an age the child becomes in the rental period; and
showing the user a single or a plurality of clothes having a size coincident with the estimated size.

2. A cloth rental method according to claim 1, wherein the cloth shown to the user is suited to a season covering the rental period.

3. A cloth rental method according to claim 1, wherein the growth information is a ratio of the recent size of the child wearing the cloth to the average size.

4. A cloth rental method according to claim 3, wherein the size of the child in the rental period is estimated by multiplying the growth information by the average size of children at the age the child becomes in the rental period.

5. A cloth rental method according to claim 1, wherein the size is a height.

6. A cloth rental program read by a computer connectable to a user terminal, making said computer:
store growth information acquired by comparing recent size of a child wearing a cloth for children with an average size of children at an age the child becomes in the rental period;
estimate, when receiving from said user terminal a request for renting a cloth with specifying a rental period, a size of the child in the rental period on the basis of the growth information; and
transmit to said user terminal data for displaying a screen to show a single or a plurality of clothes having a size coincident with the estimated size.

7. A cloth rental service receiving method, comprising steps of:
making a user specify recent size and recent age of a child wearing a cloth and a rental period; and
showing the user a single or a plurality of clothes coincident with a size of the child in the rental period, which is estimated based on growth information acquired by comparing the recent size of the child with an average size of children at an age the child becomes in the rental period.

8. A cloth rental service receiving program read by a computer connectable to a server sending back, upon receiving a predetermined request, a screen corresponding to this request, making said computer:
accept information on recent size and recent age of a child wearing a cloth and a rental period from a user;
send the information to said server transmit;
receive, from said server, data for displaying a screen to show a single or a plurality of clothes having a size coincident with a size of the child in the rental period, which is estimated based on growth information acquired by comparing the recent size of the child with an average size of children at an age the child becomes in the rental period; and
display the screen based on the data.
